(19) United States
(12) Patent Application Publication
(10) Pub. No.: US 2009/0268796 A1
(43) Pub. Date: Oct. 29, 2009

(54) TRANSCEIVER ARCHITECTURE

(76) Inventor: HANY SHENOUDA, Calgary (CA)

Correspondence Address: BENNETT JONES LLP, 3400 ONE FIRST CANADIAN PLACE, PO BOX 130, TORONTO, ON, M5X 1A4, CA

(21) Appl. No.: 12/431,133

(22) Filed: Apr. 28, 2009

Related U.S. Application Data
(60) Provisional application No. 61/048,784, filed on Apr. 29, 2008.

(51) Int. Cl. H04L 5/16

(52) U.S. Cl. 375/222

(57) ABSTRACT

A transmitter and a receiver apparatus suitable for a radio modem. According to an embodiment, the receiver apparatus comprises an input stage, an intermediate frequency stage and a demodulation and output stage. The input stage receives a signal from a transducer (e.g. a radio antenna) and generates a receive signal for the intermediate frequency stage. The intermediate frequency stage is configured to at least partially down-convert the receive signal for the demodulation and output stage. The demodulation stage is configured to demodulate the receive signal and generate a corresponding digital receive output signal. According to an embodiment, the transmitter apparatus comprises a transmitter signal modulation stage and a transmitter stage.

### FIELD OF THE INVENTION

The present invention relates to wireless data equipment, and more particularly to radio modems that operate across a wide range of frequency bands, for example, license and/or free frequency bands.

### BACKGROUND OF THE INVENTION

In the art, there are radio modems with known receiver architectures for demodulating a signal.

Superheterdyne double conversion receivers are a known architecture and deliver adequate performance. Such receivers, however, are expensive and are only able to receive signals in a narrow frequency range, for example, when good RF blocking (interference immunity) and phase noise performance are required. Transmitters known in the art also have a limited frequency range of operation in order to achieve good phase noise performance and to meet tight regulatory emission masks (e.g. FCC Part 90). In order to cover a wide frequency range (i.e. different frequencies of operation), a manufacturer needs to make and support numerous models of superheterdyne double conversion receivers.

Low and zero intermediate frequency (IF) receivers are also known in the art but suffer from different limitations. These receivers suffer from low interference blocking and/or lower adjacent channel rejection which allows unwanted signals to contaminate the desired passband signal. The rejection of the interfering signal can be optimized by calibrating the in-phase (I) and quadrature (Q) receiver components, however, the calibration process increases installation and production costs. Furthermore, to achieve a high dynamic frequency range the receivers typically use higher order analog to digital conversion circuits, which further increases the cost and/or power consumption of the circuit.

In view of at least these deficiencies, a need remains in the art for improvements in radio modem and wireless communication systems design.

### BRIEF SUMMARY OF THE INVENTION

The present invention comprises embodiments of a transceiver architecture and embodiments for an improved radio modem.

According to a first aspect, there is provided a radio modem comprising: a transmitter module and a receiver module; a transducer, the transducer having an input port coupled to said transmitter module and an output port coupled to the receiver module; the receiver module including a receiver stage having an input port coupled to the output port of the transducer and including a receiver stage output port, an intermediate frequency stage having an input port coupled to the receiver stage output port and including an intermediate frequency stage output port, a channel selection stage having an input port coupled to the intermediate frequency stage output port, and a demodulation and output stage having an input port coupled to the intermediate frequency stage output port; and the transmitter module including a transmit signal modulation stage and a transmitter stage, the transmit signal modulation stage having an input port for receiving a transmit signal input and being configured to generate a transmit signal output on an output port coupled to the transmitter stage, and the transmitter stage having a transmit signal output port coupled to the input port of the transducer.

According to another aspect, there is provided a receiver module for a communication device, the receiver module comprises: a receiver stage having an input port for receiving a receive signal from a transducer and a receiver stage output port; an intermediate frequency stage having an input port coupled to the receiver stage output port and including an intermediate frequency stage output port; a channel selection stage having an input port coupled to the intermediate frequency stage output port and including a channel selection stage output port; a demodulation and output stage having an input port coupled to the channel selection stage output port and an output port for a receive output signal and the intermediate frequency stage is configured to at least partially down-convert a receive input signal from the receiver stage to produce a receive signal having a lower frequency, and the intermediate frequency stage is configured to be responsive to one or more control signals generated by a controller.

According to another aspect, there is provided a transmitter module suitable for a communication device, and the transmitter module comprises: a transmit signal modulation stage, the transmit signal modulation stage having an input port for receiving a transmit signal input and being configured to generate a transmit signal output on an output port; and a transmitter stage having an input port coupled to the output port of the transmit signal modulation stage, and being configured to generate a transmit signal on an output port coupled to the input port of the transducer.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference is made to the accompanying drawings which show, by way of example, embodiments of the present invention, and in which:

FIG. 1 shows in block diagram form a radio modem according to an embodiment of the present invention;

FIG. 2 shows in schematic form a receiver circuit for the radio modem according to an embodiment; and

FIG. 3 shows in schematic form a transmitter circuit for the radio modem according to an embodiment.

In the drawings, like references indicate like elements or components.

### DETAILED DESCRIPTION OF AN EMBODIMENT

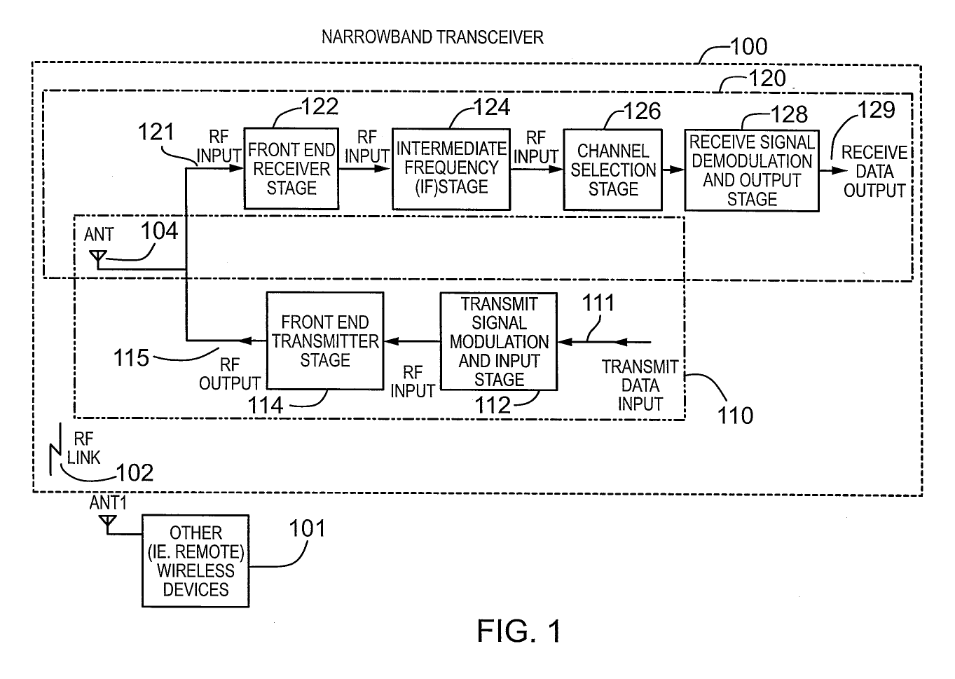

Reference is made to FIG. 1, which shows in block diagram form a radio modem according to an embodiment of the present invention and indicated generally by reference 100. The radio modem 100 as described is suitable to either a license frequency band or a free frequency band environment or application. It will be appreciated that the invention or aspects of the invention may be applicable to other types of radio modems or wireless communication applications.

As depicted in FIG. 1, the radio modem 100 provides a communication (e.g. wireless) link 102, comprising a transmit channel and/or a receive channel, for sending to and/or receiving information from other radio or wireless devices, indicated generally by reference 101. The other device 101 includes, for example, a radio modem, a wireless network router, and a wireless handheld communication device such as a cellular phone or a Blackberry™ device. The channels in the communication link 102 are implemented utilizing optical communication or radio communication techniques.

As depicted in FIG. 1, the radio modem 100 includes a transducer 104, for example, a radio antenna. The radio modem 100 comprises a transmitter circuit 110 and a receiver circuit 120. In one exemplary implementation, the transmitter circuit 110 comprises a transmit data input and modulation stage 112, and a transmitter front-end stage 114. In known manner, the transmitter circuit 110 is configured to convert transmit information, e.g. digital data, applied at a transmit data input 111 into a wireless (e.g. FM) signal, which is transmitted by the antenna 104.

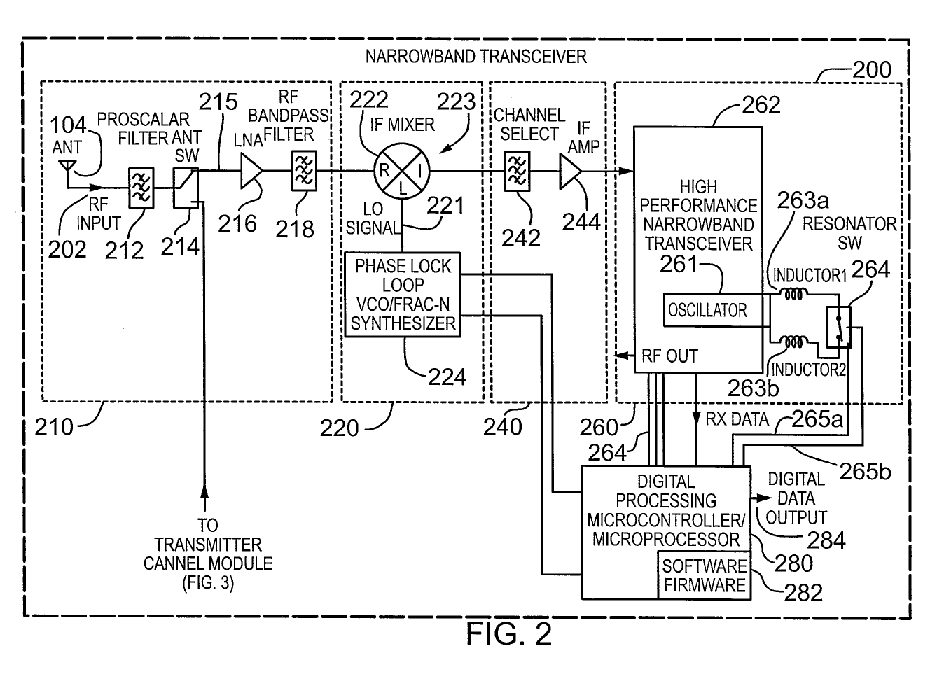

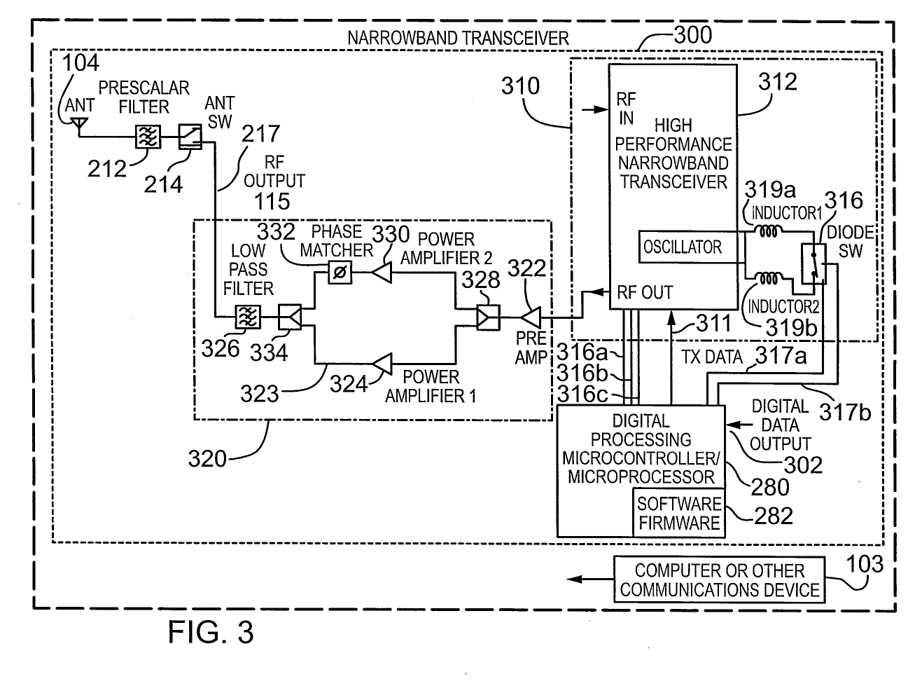

Referring to FIG. 1, the receiver 120 comprises a front-end receiver stage or module 122, an intermediate frequency (IF) stage 124, a channel selection stage 126, and a receive signal demodulation and output stage 128. The front-end receiver stage 122 inputs a radio signal 121 (e.g. from the receive channel in the communication link 102) from the antenna 104 which converts the wireless signal to the radio signal 121. The intermediate frequency (IF) stage 124 down-converts (for example, partially) the signal, as will be described in more detail below with reference to FIG. 2. The channel selection stage 126 is configured to allow input signals within a certain (e.g. “tuned”) frequency range to continue to the receive signal demodulation and output stage 128. The receive signal demodulation and output stage 128 is configured to receive the output from the channel selection stage 126 and convert (e.g. demodulate) the signal into receive data (e.g. digital data stream). The digital stream data is outputted at a receive data output 129 for further processing by an electronic device, for example, a mobile communication device or a computer, and/or an application program (e.g. web browser), for example, as indicated generally by reference 103 in FIG. 3.

According to an embodiment, the functionality associated with the receive signal demodulation and output stage 128 of the receiver 120 and the transmit signal modulation and input stage 112 of the transmitter 110 is implemented and performed in one component or module, for example, a narrowband transceiver, such as Analog Devices ADF7021 transceiver device). According to an embodiment, a microprocessor (for example, as shown in FIGS. 2 and 3 and is indicated generally by reference 280) is configured (for example, under stored program control) to control whether the radio modem is operating in “transmit mode” or “receive mode” as will be within the understanding of one skilled in the art. To transmit information, the microprocessor 280 (for example, as shown in FIG. 3) is configured (e.g. operates or executes instructions in firmware and/or software) to actuate an antenna switch 214 (FIG. 3) to close the transmit circuit 110 and allow the RF output signal 115 to continue to its intended destination via the RF link 102, as described in more detail below with reference to FIG. 3. To receive information, the microprocessor (for example, as shown in FIG. 2) is configured to execute instructions (for example, in firmware and/or software) to actuate the antenna switch 214 (FIG. 2) to close the receive circuit 120 and allow the RF input signal 121 that is received via the communication link 102 to continue along the receive circuit 120, as described in more detail below with reference to FIG. 2.

Reference is next made to FIG. 2 which shows in schematic form an embodiment of the receiver channel module or circuit, which is indicated generally by reference 200. According to an embodiment, the receiver channel circuit 200 is configured to partially convert, i.e. “down-convert”, a receive signal 202 (i.e. the RF input signal 121 in FIG. 1) from the antenna 104 into a lower or intermediate frequency (IF) signal, which is then subjected to further processing as described in more detail below. According to an embodiment and as shown in FIG. 2, the receiver channel circuit 200 comprises a front end receiver stage 210, an intermediate frequency (IF) mixer stage 220, and a receive signal demodulation and output stage 260. According to an embodiment, the receiver channel circuit 200 includes a channel selection stage indicated generally by reference 240 in FIG. 2. According to another aspect, the receiver channel circuit 200 includes microprocessor 280. The microprocessor 280 operates under stored program control, for example, software or firmware stored in non-volatile or program memory and indicated generally by reference 282, and is configured to execute instructions in the firmware 282 to provide the functionality and operations associated with the receiver, as described in more detail below.

As shown in FIG. 2, the front-end receiver stage 210 includes a pre-scalar filter 212, an antenna switch 214, a low noise amplifier (LNA) 216, and a bandpass filter 218. The intermediate frequency (IF) stage 220 includes an IF mixer 222 and a frequency synthesizer component or device 224. The IF mixer 222 is configured to receive an input from the bandpass filter 218 and another input from the frequency synthesizer 224. The channel selection stage 240 includes a channel selector 242 and an intermediate frequency (IF) amplifier 244. The receive signal demodulation and output stage 260 comprises a narrowband transceiver, indicated generally by reference 262.

Referring again to FIG. 2, the receive signal (i.e. RF input signal 121 in FIG. 1) 202 is fed into the pre-scalar filter 212 which has a low noise figure (for example, in the range of 0.5 dB to 1.5 dB). The pre-scalar filter 212 may be implemented using various technologies, such as, helical, ceramic, a tuned LC network, micro-strip, cavity or waveguides, as will be within the understanding of one skilled in the art. According to another aspect, the pre-scalar filter 212 provides a filtering function and depending on the radio architecture is configured as a lowpass, bandpass, highpass or bandstop filter. The output of the pre-scalar filter 212 is fed to the antenna switch 214 and switched or routed (for example, under control of the microprocessor 280, i.e. executing an algorithm or instructions in software or firmware 282) to an output 215 which is coupled to the input of the low noise amplifier 216. The low noise amplifier 216 is configured to amplify the output signal from the pre-scalar filter 212, while introducing minimum noise figure (e.g. in the range of 0.5 dB to 1 dB). According to an embodiment, the low noise amplifier 216 is configured or implemented to provide a gain in the range of 14 to 20 dB. The amplified output signal from the low noise amplifier 216 is next passed through the bandpass filter 218. According to an embodiment, the bandpass filter 218 is implemented with a passband or bandwidth of the entire desired frequency operating range (e.g. 400 MHz to 480 MHz).

As shown in FIG. 2, the output from the bandpass filter 218 is fed to one input of the IF mixer 222. The IF mixer 222 has another input which receives a frequency signal which is generated by a frequency synthesizer indicated generally by reference 224. According to an embodiment, the frequency synthesizer 224 generates an IF frequency signal (i.e. local oscillator or LO signal) 221 having a frequency, for example, in the range 70 MHz to 150 MHz. The IF mixer 222 is configured to mix the signal from frequency synthesizer 224 with the signal from the bandpass filter 218 to produce a lower intermediate frequency (IF) signal 223 at the output of the IF mixer 222. According to an embodiment, the Frequency Synthesizer 224 is configured to be responsive, e.g. tunable with high resolution (e.g. 100 Hz), in response to one or more control signals generated by the microprocessor 280. According to an embodiment, the firmware 282 includes one or more algorithms, functions, objects or code components configured to program the operational or desired receive frequency of the radio modem using a serial peripheral interface (SPI) port. The programming sequence of the frequency synthesizer 224 will be defined by the manufacture of the device as will be within the understanding of one skilled in the art. According to another embodiment, the function(s) performed by the microprocessor 280 and/or firmware 282 may be implemented in hardware, in a programmable or configurable hardware device and/or a hardware/software combination.

According to an embodiment of the present invention, the frequency synthesizer 224 is implemented with a plurality of tuning elements and the tuning elements are configured to be selectable in response to control signals generated by the microprocessor 280 in order to generate a local oscillator (LO) signal 221 having a desired frequency for input to the IF mixer 222. According to an aspect, the receiver 200 is configurable for operation over a wide frequency range by controlling or setting the local oscillator (LO) signal 221 to the IF mixer 222 with the frequency synthesizer 224. In a typical application, the RF frequency signal (i.e. the local oscillator signal 221) generated by the Frequency Synthesizer 224 and applied as the second input to the IF mixer 210 is in the range of 300 MHz to 420 MHz.

According to an embodiment of the present invention, the software/firmware 282 is configured to re-program or reconfigure the local oscillator (LO) signal 221 while the radio modem is operational in the field without interruption to the communication link. In such a case, the radio modem can be modified to receive signals in a different frequency band. According to an embodiment, the software/firmware 282 is configured to allow the receiver 200 to receive multiple channels of wireless information by programming or configuring the frequency registers inside the frequency synthesizer 224, as will be within the understanding of one skilled in the art.

Referring again to FIG. 2, the mixed output signal 223 generated by the IF mixer 222 is fed into the channel selection stage 240. As described above, the channel selection stage 240 comprises the channel selector 242 and the intermediate frequency (IF) amplifier 244. According to an embodiment, the channel selector 242 is implemented in the form of a highly selective bandpass filter that allows signals in a narrow frequency range or passband to continue along the receiver circuit. For example, the channel selector 242 may comprise a crystal, saw, baw, helical, lumped element or quartz filter or any other suitable device. According to an embodiment, the passband frequency range is typically in the range 12 kHz to 30 kHz with a center frequency from 70 MHz to 150 MHz. The channel selector 242 prevents signals that are outside of the desired frequency range from continuing along the path of the circuit, for example, by sufficiently attenuating them to be effectively negligible. As shown, the output from the channel selector 242 is fed into the intermediate frequency (IF) amplifier 244. According to an embodiment, the IF amplifier 244 is configured to amplify the signal with a gain in the range of 10 dB to 20 dB.

As depicted in FIG. 2, the output from the intermediate frequency (IF) amplifier 244 is fed into the narrowband transceiver 262 in the receive signal demodulation and output stage 260, after the noise and undesired signals are removed by the channel selector 242. The narrowband transceiver 262 is configured or controlled by the microprocessor 280 (i.e. under stored program control) to provide a constant IF frequency (e.g. 90 MHz), and demodulation bandwidth (e.g. 18.5 kHz) and signal type (2 level FSK) in order to demodulate/convert the processed receive signal into receive data, for example, in the form of a digital data stream. The narrowband transceiver 262 receives the desired signal at the IF frequency. As described above and according to an embodiment, the IF frequency is substantially constant. According to another aspect, the IF frequency is not changed, i.e. re-tuned, on a channel-by-channel basis, but is rather tuned through the frequency synthesizer 224. According to an embodiment, the microprocessor 280 executes an algorithm or function (in firmware or software 282) to generate control signals 265a and 265b and actuate switches 267 which activate/deactivate inductors 263a and 263b coupled to the oscillator 261. The inductors are configured to modify the tuning range of the narrowband transceiver in order to support the required IF frequency for demodulation. According to an embodiment, the microprocessor will not actuate 265a or 265b in order to achieve the IF tuning range in receive mode (e.g. 90 MHz).

The output of the narrowband transceiver 262 is coupled to an input port on the microprocessor 280. The firmware 282 executed by the microprocessor 280 includes a function, object or other type of code component, which is executed to convert or “re-package” the digital data stream into a format that can be understood by other types digital devices (e.g. a bit stream is re-packaged into groups of 8 bits to represent a byte of data). The re-packaged digital stream is outputted by the microprocessor 280, i.e. as a digital data output 284, to the digital device, for example, a mobile communication device or a computer 103 (FIG. 3).

Reference is next made to FIG. 3 which shows in schematic form an embodiment of the transmitter channel module or circuit, which is indicated generally by reference 300. The transmitter channel circuit 300 comprises a transmit data input and modulation stage 310 and a front end transmission stage 320.

As shown, the transmit data input and modulation stage 310 comprises a narrowband transceiver 312. According to an embodiment, narrowband transceiver 312 corresponds to the narrowband transceiver 262 of FIG. 2, and is configured to directly modulate a transmit input signal 311 across a wide frequency range. The narrowband transceiver 312 includes a local oscillator or LO (indicated generally by reference 314). According to an embodiment, the oscillator 314 is configured to be responsive to control signals generated by the microprocessor 280 operating under stored program control, e.g. a function or code component in the firmware 282. According to an embodiment, the microprocessor 280 executes an algorithm or instructions in firmware or software 282 to program or configure the local oscillator (LO) 314 to the desired frequency for transmission.

According to an embodiment, the local oscillator 314 is referenced from the maximum allowable input clock rate in order to achieve the best phase noise performance to meet regulatory emission mask (e.g. FCC Part 90 emission mask D)

According to an embodiment, the microprocessor 280 executes a function or instructions in firmware or software 282 to generate control signals on outputs 316a, 316b and 316c, for example, using a serial peripheral interface or SPI. The control signals 316a to 316c (e.g. the control signals may be data, clock and chip select) according to an embodiment configure the narrowband transceiver 312 into transmit mode and set the modulation characteristics and the transmission frequency. According to an embodiment, the narrowband transceiver 312 is implemented using an ADF7021 device from Analog Devices and includes registers for configuring the operation and/or functions associated with the device. The particular settings/configurations are detailed in the device datasheet and will be within the understanding of one skilled in the art. According to an embodiment, the microprocessor 280 generates control signals 317a and 317b to actuate diode switches 318, which activate/deactivate inductors 319 coupled to the oscillator 314. The inductors are configured to extend the tuning range of the narrowband transceiver 312 by changing the resonating frequency range of the oscillator 314, and thereby the transmitter 300 to a specific transmit frequency, for example, in the range 350 MHz to 390 MHz when 317a is actuated and 317b is not actuated and 390 MHz to 430 MHz when 317a is not actuated and 317b is actuated.

According to another aspect, the software/firmware 282 or selected code modules or functions are configurable locally, remotely, or autonomously to send various control signals to the narrowband transceiver 312 so that the radio uses different frequencies over a given time period (for example frequency hopping). This allows a user to adjust the transmit frequency of the radio modem 100, for example, even while the radio modem is operational in a field environment and without user intervention.

The narrowband transceiver 312 is configured to perform direct modulation of the RF transmit input signal 311. According to an embodiment, the narrowband transceiver also demodulates the signal after filtering by the channel selector filter 242 (FIG. 2) and amplification at the intermediate frequency (IF) and the IF amplifier 244 (FIG. 2) of the receiver 200 (FIG. 2) as described above.

The front-end transmission stage 320 comprises a pre-amplifier 322, a power splitter 328, a power amplifier 323, a phase matcher 332 and a power combiner 334, configured as shown in FIG. 3. According to an implementation, the power amplifier 323 is configured as a parallel cascaded power amplifier comprising amplifiers 324 and 330. According to an aspect, the parallel power amplifier configuration increases the RF transmission power while operating at low supply voltage, for example, Skyworks Solutions Inc. SKY65116-21 components are paralleled to provide 37 dBm of RF power at a supply voltage of 3.6 volts to 4.5 volts.

In operation, the narrowband transceiver 312 generates a modulated signal at RF output 313, which is fed to the pre-amplifier 322 and according to an embodiment the pre-amplifier may be substituted for an attenuator depending on the required gain of the power amplifiers 324 and 330. According to an embodiment, the power splitter 328 provides power to both amplifiers 324 and 330 with approximately 3.5 dB coupling loss. According to an embodiment, the amplifiers 324 and 330 in the power amplifier 323 are configured to provide a gain in the range of 27 dB to 33 dB (e.g. SKY65116-21). The output signal from the power amplifier 330 is phase matched such that the superposition of the signal from the amplifiers 324 and 330 in the power combiner 334 is constructive and increases the output power. According to an embodiment, the front-end transmission stage 320 includes a low pass filter 326 to remove the harmonics. According to an embodiment, the low pass filter 326 is configured with a cutoff frequency in the range of approximately 550 MHz to 600 MHz. The signal from the power combiner 334 is filtered by the low pass filter 326 and fed to a second terminal (i.e. input) 217 on the antenna switch 214. In transmit mode, the microprocessor 280 is configured to actuate the antenna switch 214 to route the input (i.e. the RF signal) on the second terminal 217 to the pre-scalar filter 212. The pre-scalar filter 212 is configured to provide a filtering function and depending on the radio architecture can comprise a lowpass, bandpass, highpass or bandstop filter. From the pre-scalar filter 212, the filtered RF signal is passed to the transducer, e.g. the antenna 104, and transmitted by the antenna 104 to other wireless devices such as radio modems or mobile communication devices, for example, as indicated by reference 101 in FIG. 1.

The present invention may be embodied in other specific forms without departing from spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A radio modem comprising:
a transmitter module and a receiver module;
a transducer, said transducer having an input port coupled to said transmitter module and an output port coupled to said receiver module;
said receiver module including a receiver stage having an input port coupled to the output port of said transducer and including a receiver stage output port, an intermediate frequency stage having an input port coupled to said receiver stage output port and including an intermediate frequency stage output port, a channel selection stage having an input port coupled to said intermediate frequency stage output port, and a demodulation and output stage having an input port coupled to said intermediate frequency stage output port, and said intermediate frequency stage being configured to at least partially down-convert a receive input signal from said receiver stage to produce a receive signal having a lower frequency;
said transmitter module including a transmit signal modulation stage and a transmitter stage, said transmit signal modulation stage having an input port for receiving a transmit signal input and being configured to generate a transmit signal output on an output port coupled to said transmitter stage, and said transmitter stage having a transmit signal output port coupled to the input port of said transducer; and
a controller configured to operate said transmitter module and said receiver module in a respective transmit mode and a respective receive mode.

2. The radio modem as claimed in claim 1, wherein said receiver module includes a channel selection stage configured with an input port coupled to said intermediate frequency stage output port and a channel selection stage output port coupled to the input port of said demodulation and output stage, and said channel selection stage being configured to pass a signal within a selected frequency stage to said demodulation and output stage.

3. The radio modem as claimed in claim 1, wherein said intermediate frequency stage is configured to be responsive to one or more control signals generated by said controller.

4. The radio modem as claimed in claim 3, wherein said intermediate frequency stage comprises an intermediate frequency mixer and a frequency synthesizer, said frequency synthesizer being configured to generate an intermediate frequency signal for input to said intermediate frequency mixer in response to said one or more control signals received from said controller, and said intermediate frequency mixer being configured with an input port for receiving said receive input signal and mixing said receive input signal with said intermediate frequency signal to produce a lower frequency receive signal at an output port coupled to the input port of said channel selection stage.

5. The radio modem as claimed in claim 4, wherein said frequency synthesizer is configured to generate an intermediate frequency signal having a frequency in the range of 70 MHz to 150 MHz.

6. The radio modem as claimed in claim 4, wherein said channel selection stage is configured to select a lower frequency receive signal having a frequency within a defined frequency selection range.

7. The radio modem as claimed in claim 6, wherein said channel selection stage comprises a bandpass filter configured with a passband frequency range of 12 KHz to 30 KHz with a center frequency of 70 MHz to 150 MHz.

8. The radio modem as claimed in claim 6, wherein said demodulation and output stage is configured to be responsive to one or more control signals generated by said controller to convert said selected lower frequency receive signal into a corresponding receive data signal.

9. The radio modem as claimed in claim 8, wherein said demodulation and output stage includes a tuning stage having a tuning range, said tuning stage being configured to be responsive to one or more tuning control signals generated by said controller for adjusting said tuning range in accordance with the intermediate frequency signal generated by said frequency synthesizer.

10. The radio modem as claimed in claim 3, wherein said transmit signal modulation stage is configured to generate a modulation signal for modulating said transmit signal input, and includes an oscillator circuit configured to vary the frequency of said modulation signal in response to one or more transmit frequency control signals generated by said controller.

11. The radio modem as claimed in claim 10, wherein said transmitter stage comprises a power splitter and a parallel cascaded power amplifier, said power splitter having an input port for receiving the modulated transmit signal from said transmit signal modulation stage, and an output port coupled to an input port of said parallel cascaded power amplifier, and said parallel cascaded power amplifier comprising first and second amplifiers coupled in parallel and each of said amplifiers being configured to generate an amplified transmit signal output for a power combiner, and said power combiner being configured to combine said amplified transmit output signals at an output coupled to the input port of said transducer.

12. The radio modem as claimed in claim 11, wherein said parallel cascaded power amplifier includes a phase matcher, said phase matcher being configured between the output of one of said amplifiers and the input to said power combiner.

13. A receiver module for a communication device, said receiver module comprising:
a receiver stage having an input port for receiving a receive signal from a transducer and a receiver stage output port;
an intermediate frequency stage having an input port coupled to said receiver stage output port and including an intermediate frequency stage output port;
a channel selection stage having an input port coupled to said intermediate frequency stage output port and including a channel selection stage output port;
a demodulation and output stage having an input port coupled to said channel selection stage output port and an output port for a receive output signal; and
said intermediate frequency stage being configured to at least partially down-convert a receive input signal from said receiver stage to produce a receive signal having a lower frequency, and said intermediate frequency stage being configured to be responsive to one or more control signals generated by a controller.

14. The receiver as claimed in claim 13, wherein said intermediate frequency stage comprises an intermediate frequency mixer and a frequency synthesizer, said frequency synthesizer being configured to generate an intermediate frequency signal for input to said intermediate frequency mixer in response to said one or more control signals received from said controller, and said intermediate frequency mixer being configured with an input port for receiving said receive input signal and mixing said receive input signal with said intermediate frequency signal to produce a lower frequency receive signal at an output port coupled to the input port of said channel selection stage.

15. The radio modem as claimed in claim 14, wherein said channel selection stage is configured to select a lower frequency receive signal having a frequency within a defined frequency selection range.

16. The receiver as claimed in claim 15, wherein said demodulation and output stage is configured to be responsive to one or more control signals generated by said controller to convert said selected lower frequency receive signal into a corresponding receive data signal.

17. The receiver as claimed in claim 16, wherein said demodulation and output stage includes a tuning stage having a tuning range, said tuning stage being configured to be responsive to one or more tuning control signals generated by said controller for adjusting said tuning range in accordance with the intermediate frequency signal generated by said frequency synthesizer.

18. A transmitter module suitable for a communication device, said transmitter module comprising:
a transmit signal modulation stage, said transmit signal modulation stage having an input port for receiving a transmit signal input and being configured to generate a transmit signal output on an output port; and
a transmitter stage having an input port coupled to the output port of said transmit signal modulation stage, and being configured to generate a transmit signal on an output port coupled to the input port of said transducer.

19. The transmitter as claimed in claim 18, wherein said transmit signal modulation stage is configured to generate a modulation signal for modulating said transmit signal input, and includes an oscillator circuit configured to vary the frequency of said modulation signal in response to one or more transmit frequency control signals generated by said controller.

20. The transmitter as claimed in claim 19, wherein said transmitter stage comprises a power splitter and a parallel cascaded power amplifier, said power splitter having an input port for receiving the modulated transmit signal from said transmit signal modulation stage, and an output port coupled to an input port of said parallel cascaded power amplifier, and said parallel cascaded power amplifier comprising first and second amplifiers coupled in parallel and each of said amplifiers being configured to generate an amplified transmit signal output for a power combiner, and said power combiner being configured to combine said amplified transmit output signals at an output coupled to the input port of said transducer.

21. The transmitter as claimed in claim 20, wherein said parallel cascaded power amplifier includes a phase matcher, said phase matcher being configured between the output of one of said amplifiers and the input to said power combiner.
